(19) United States
(12) Patent Application Publication
(10) Pub. No.: US 2009/0319492 A1
(43) Pub. Date: Dec. 24, 2009

(54) APPARATUS PROCESSING USER GENERATED DATA AND METHOD OF CONTROLLING THE APPARATUS

(75) Inventors: Shinji Todaka, Inagi-shi (JP); Yuichi Hosoda, Tokyo (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/487,363

(22) Filed: Jun. 18, 2009

(30) Foreign Application Priority Data
Jun. 19, 2008 (JP) 2008-160776
Nov. 20, 2008 (JP) 2008-296699

(51) Int. Cl. G06F 17/30

(52) U.S. Cl. 707/3; 707/204; 707/E17.014; 707/E17.005

(57) ABSTRACT

An apparatus uninstalling a target application includes a processing unit configured to move user generated data from a user-generated-data storage area managed by the target application to be installed to a user-generated-data storage area managed by another application that is installed.

### BACKGROUND OF THE INVENTION

1. Field of the Invention

The present invention relates to an apparatus that processes user generated data and a method of controlling the apparatus.

2. Description of the Related Art

Heretofore, application platforms capable of installing and uninstalling applications in order to allow users to change the operation modes of apparatuses have been proposed. When the users uninstall applications in such an environment, data that is generated by the users using the applications cannot be possibly processed.

Japanese Patent Laid-Open No. 2002-073338 discloses a method of moving application data generated by a user using an old version to the application management area of a new version in version-up of the application. With this method, the user can use the application in the new version to use the user generated data of the old version.

In the method disclosed in Japanese Patent Laid-Open No. 2002-073338, the user can access the user generated data that is uninstalled only in the version-up of the application (only when the application is uninstalled and installed). However, when the application is uninstalled, instead of the version-up, it is not possible to process the data on the application.

In other words, when the application is uninstalled without installation of a new application, the user cannot use the user generated data managed by the application that is uninstalled.

### SUMMARY OF THE INVENTION

According to an embodiment of the present invention, an apparatus uninstalling a target application includes a processing unit configured to move user generated data from a user-generated-data storage area managed by the target application to be installed to a user-generated-data storage area managed by another application that is installed.

According to another embodiment of the present invention, an apparatus includes an identifying unit configured to identify an application that is not invoked and a search unit configured to search a user-generated-data storage area of the identified application for user generated data.

According to another embodiment of the present invention, an apparatus includes an identifying unit configured to identify a user-generated-data storage area that is not managed by an application that is invoked from user-generated-data storage areas and a search unit configured to search the identified user-generated-data storage area for a document.

According to another embodiment of the present invention, a method of controlling an apparatus that uninstalls a target application includes the step of moving user generated data from a user-generated-data storage area managed by the target application to be installed to a user-generated-data storage area managed by another application that is installed.

Further features of the present invention will become apparent from the following description of exemplary embodiments with reference to the attached drawings.

### BRIEF DESCRIPTION OF THE DRAWINGS

FIG. 1 is a block diagram schematically showing an example of the configuration of an image forming apparatus according to a first exemplary embodiment of the present invention.

FIG. 2A is a table illustrating an example of the data structure of application management information and FIG. 2B is a table illustrating another example of the data structure of the application management information.

FIG. 3 is a flowchart showing an example of a process of uninstalling an application according to the first exemplary embodiment of the present invention.

FIG. 4 illustrates an example of an application selection screen where a destination application is selected.

FIG. 5 illustrates an example of the hierarchical structure of a data management area according to a second exemplary embodiment of the present invention.

FIG. 6 is a table illustrating an example of management information about user generated data.

FIG. 7 is a flowchart showing an example of a process of searching for invalid data according to the second exemplary embodiment of the present invention.

FIG. 8A illustrates an example of an application selection screen where an application to be used is selected and FIG. 8B illustrates an example of another application selection screen where an application to be used is selected.

FIG. 9 illustrates an example of a screen where the result of invalid document search is displayed.

FIG. 10 illustrates an example of the logical structure of an indirect storage unit.

FIG. 11 is a flowchart showing an example of a process of searching for invalid data according to a third exemplary embodiment of the present invention.

FIG. 12 is a flowchart showing in detail one step in the process of uninstalling an application, according to the second exemplary embodiment of the present invention.

### DESCRIPTION OF THE EMBODIMENTS

Embodiments of the present invention will herein be described with reference to the attached drawings.

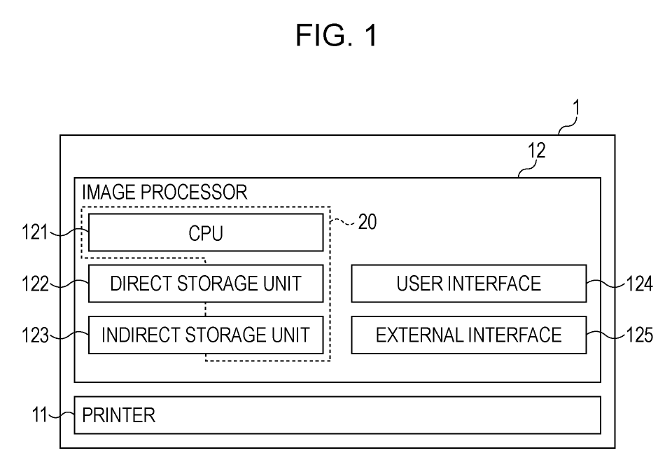

FIG. 1 is a block diagram schematically showing an example of the configuration of an image forming apparatus to which an application platform is applied, according to a first exemplary embodiment of the present invention.

Referring to FIG. 1, an image forming apparatus 1 includes a printer 11 and an image processor 12.

The image processor 12 includes a central processing unit (CPU) 121, a direct storage unit 122 (for example, a random access memory (RAM)), an indirect storage unit 123 (for example, a hard disk drive (HDD)), a user interface 124, and an external interface 125.

The direct storage unit 122 directly exchanges data with the CPU 121, and the indirect storage unit 123 exchanges data with the CPU 121 via the direct storage unit 122. The direct storage unit 122 stores various application programs and platform programs.

The user interface 124 includes a keyboard, a mouse, a display device, etc. and is capable of displaying data (screen data) in response to an instruction received from a user.

The external interface 125 is capable of receiving and transmitting data from and to an external apparatus. The external apparatus is, for example, an external storage apparatus, such as an external HDD or an external universal serial bus (USB) memory, or a separate apparatus, such as a separate host computer or image forming apparatus, connected to the image processor 12 over a network.

The CPU 121 is capable of moving (storing) a platform program stored in the indirect storage unit 123 to the direct storage unit 122. When the movement of the platform program is completed, the CPU 121 gets into a state where the CPU 121 can execute the platform program. The state in which “the CPU 121 gets into the state where the CPU 121 can execute a platform program” is hereinafter referred to as invocation of a platform unit 20.

A combination of the CPU 121, an area where the platform programs are stored in the direct storage unit 122, and an area where information (for example, calculation results) resulting from processing of the platform programs by the CPU 121 is stored in the direct storage unit 122 and the indirect storage unit 123 is hereinafter referred to as the platform unit 20.

The platform unit 20 is capable of moving (storing) an application program stored in the indirect storage unit 123 to the direct storage unit 122. When the movement of the application program is completed, the platform unit 20 gets into a state where the platform unit 20 can execute the application program (application). The state in which “the platform unit 20 gets in to the state where the platform unit 20 can execute an application program” is hereinafter referred to as invocation of the application by the platform unit 20.

In addition, the platform unit 20 is capable of deleting an application stored in the direct storage unit 122 from the direct storage unit 122 while the application is kept in the indirect storage unit 123. This is hereinafter referred to as stopping of the application by the platform unit 20.

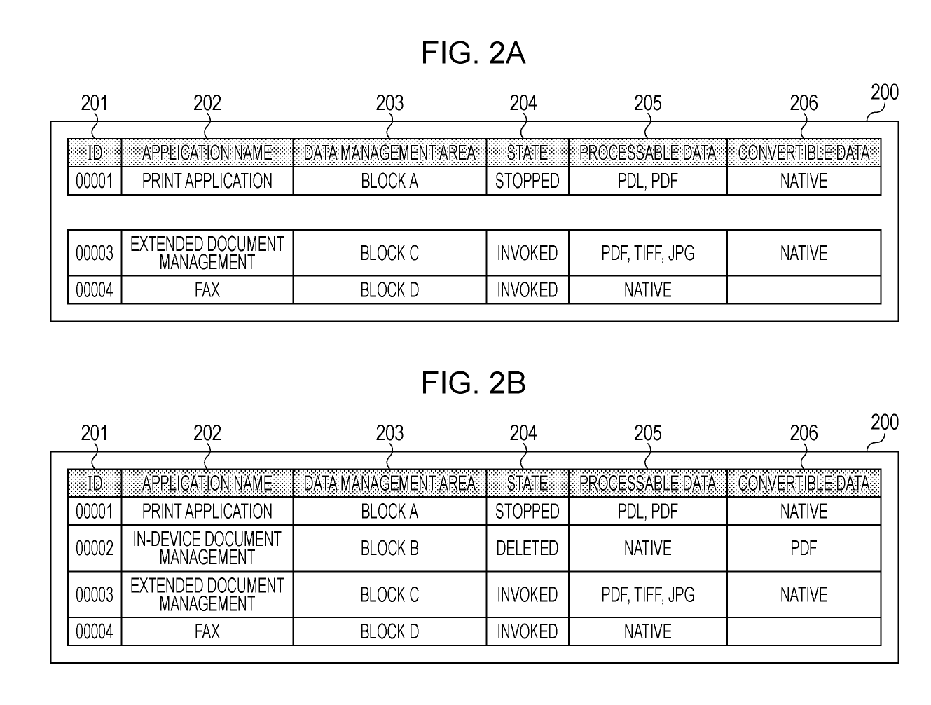

The platform unit 20 is capable of receiving an application through the external interface 125 and storing the received application in the indirect storage unit 123. In this case, the platform unit 20 generates setup data necessary to operate the application. The platform unit 20 generates a record used for managing the application in application management information (application management data 200) described below with reference to FIG. 2A. The platform unit 20 generates a data management area for the application, described below, in the indirect storage unit 123 and stores necessary data in the data management area. Specifically, for example, the platform unit 20 stores the setup data necessary to operate the application in the data management area in the indirect storage unit 123. User generated data is equivalent to user data.

The storage of an application in the indirect storage unit 123 and the generation of a record used for managing the application are hereinafter referred to as installation of the application.

Furthermore, the platform unit 20 is capable of deleting an application stored in the indirect storage unit 123 from the indirect storage unit 123. In conjunction with the deletion of the application, the platform unit 20 is capable of updating the record used for managing the application or deleting the record. The platform unit 20 is also capable of deleting all the data in the data management area to open the data management area or of deleting part of the data in the data management area to reduce the size of the data management area.

The deletion of an application from the indirect storage unit 123 and the update of the record used for managing the application or the deletion of the record are hereinafter referred to as uninstallation of the application.

FIG. 2A is a table illustrating an example of the data structure of application management information.

Referring to FIG. 2A, the application management data 200 is stored in the platform unit 20.

A data item 201 indicates the identifier (ID) of each application and the ID in the data item 201 is unique in the application management data 200.

A data item 202 indicates the name of each application.

A data item 203 indicates the data management area managed by each application.

A data item 204 indicates the state of each application. The data item 204 has a value of “Invoked”, “Stopped”, or “Deleted”. When the platform unit 20 invokes the application, the data item 204 is set to “Invoked. When the platform unit 20 stops the application, the data item 204 is set to “Stopped”. When the application is uninstalled from the platform unit 20, the application does not appear in the data structure in FIG. 2A.

A data item 205 indicates the data format of user generated data that can be processed by the application indicated in the data item 201. The extension used in the file name of the user generated data is set as the value of the data item 205. Multiple values may be concurrently stored in the data item 205.

A data item 206 indicates the format of the data resulting from conversion of the format of user generated data. For example, Page Description Language (PDL) data and Portable Document Format (PDF) data are shown as the processable data for a print application in FIG. 2A. Since the PDL data and the PDF data can be converted into NATIVE data, the data item 206 has a value of NATIVE. The extension is set as the value of the data item 206, as in the data item 205.

According to the first exemplary embodiment of the present invention, one row of the application management data 200 is called a record. The record includes the data item 201, the data item 202, the data item 203, the data item 204, the data item 205, and the data item 206 in the first exemplary embodiment. Each record indicates the management information about one application. The information used by the platform unit 20 to manage an application is called the record in this specification.

The platform unit 20 adds a record to the application management data 200 when a new application is installed. At the addition of the record, the data items 202, 203, 205, and 206 are blank and the data item 204 has a value of “Stopped”. First, the platform unit 20 generates the ID of the new application and writes the ID in the data item 201 in the added record. This ID is generated so as not to duplicate the data items 201 of the other records in the application management data 200.

Next, the platform unit 20 writes data in the data items 202, 205, and 206 on the basis of application information that is passed from an installer and that indicates an application name and data processable in the application.

Finally, the platform unit 20 generates a data management area and writes data indicating the data management area in the data item 203.

The platform unit 20 updates the data item 204 to “Invoked” when the application is invoked.

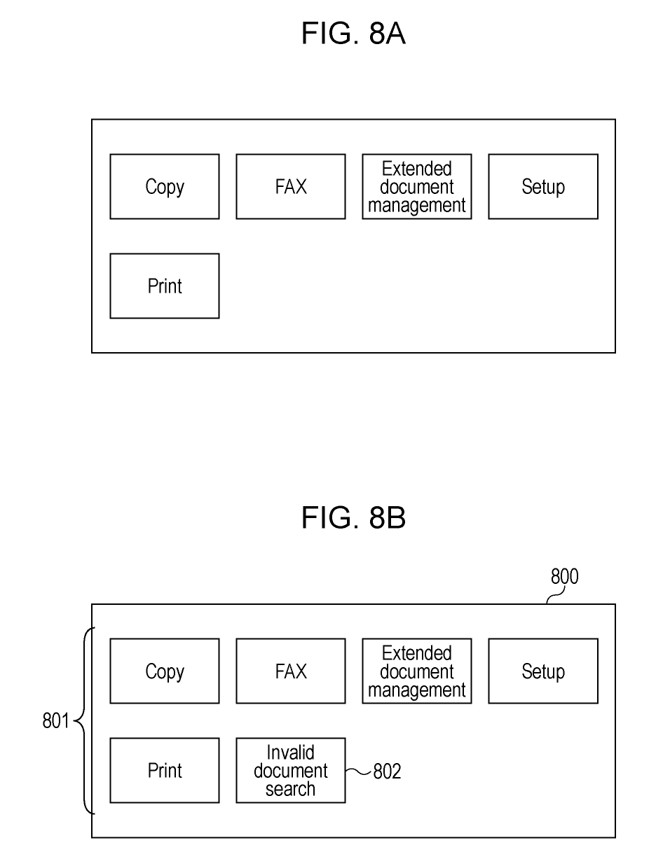

When the user wants to access the user data (the user generated data) managed by a specific application, the user selects the specific application with the user interface 124. For example, when the user wants to access the user data managed by a Copy application, the user touches a “Copy” button on a display screen illustrated in FIG. 8A to select the Copy application. The user can access the user data managed by the Copy application on a screen displayed by the selection. Since only the buttons corresponding to the applications that are invoked are displayed on the display screen in FIG. 8A, the user cannot access the user data managed by applications that are not invoked.

The user also cannot access the user data that has been managed by uninstalled applications because the uninstalled applications correspond to the “applications that are not invoked”.

According to the first exemplary embodiment of the present invention, in order to allow the user to access the user data managed by an application to be uninstalled, the user data is moved to the data management area of an application that is not to be uninstalled and that has been installed.

The user data hereinafter means the data generated by the platform unit 20 in the image forming apparatus 1 in response to an instruction of, for example, a user who has used the image forming apparatus 1 with the user interface 124. However, according to another exemplary embodiment, the user data may mean the data generated by the platform unit 20 in response to an instruction of only a user who currently issues an uninstallation instruction with the user interface 124. In this case, information 605 (not shown) indicating the user who has issued the instruction to generate the data is added to each record in user data management information described below, in addition to a document ID in a data item 601 and a data name in a data item 602.

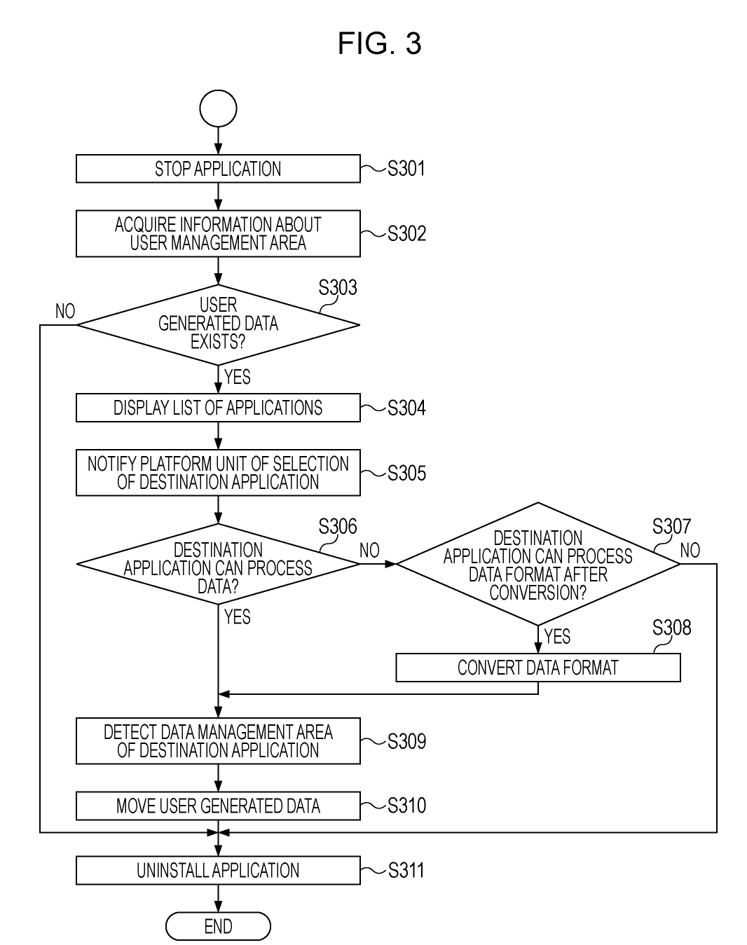

FIG. 3 is a flowchart showing an example of a process of uninstalling an application, performed by the platform unit 20, according to the first exemplary embodiment of the present invention.

At reception of an instruction to uninstall an application from the user, the user interface 124 notifies the platform unit 20 of the reception of the instruction. The platform unit 20 performs the process shown in FIG. 3 in response to the notification.

In Step S301, the platform unit 20 stops the target application to be uninstalled. The platform unit 20 switches the state of the application from “Invoked” to “Stopped”. If the target application to be uninstalled has already been stopped before Step S301, Step 301 is skipped. The platform unit 20 determines whether the application is stopped or invoked on the basis of the data item 204 indicating the state of the application.

In Step S302, the platform unit 20 acquires information about the data management area of the target application to be uninstalled. The acquisition of the information about the data management area is performed by the platform unit 20 that acquires information from the data in the data item 203 in the record for the target application to be uninstalled in the application management data 200.

In Step S303, the platform unit 20 determines whether user generated data exists in the data management area of the target application. This determination is performed by the platform unit 20 that searches the data management area for user generated data. If the platform unit 20 determines in Step S303 that user generated data exists (YES in Step S303), the process goes to Step S304. If the platform unit 20 determines in Step S303 that user generated data does not exist (NO in Step S303), the process skips Steps S304 to S310 to go to Step S311.

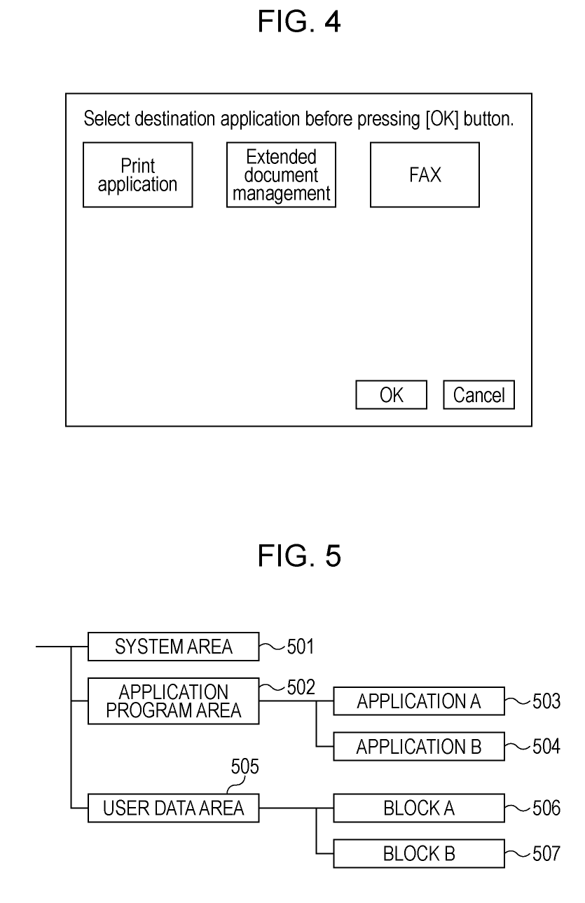

In Step S304, the platform unit 20 instructs the user interface 124 to display a list of applications that have been installed. The user interface 124 displays an application selection screen illustrated in FIG. 4 in response to the instruction. The applications managed as the application management data 200 (that is, the installed applications) are displayed in the list of applications.

In the display of the list of applications, only specific applications among all the applications that have been installed may be displayed. An application capable of processing the user generated data managed by the application to be uninstalled is displayed as an application of a first type among the specific applications. An application that becomes capable of processing the user generated data managed by the application to be uninstalled through conversion (format conversion) is displayed as an application of a second type among the specific applications. All the applications other than the applications of the first and second types are excluded from the specific applications. Whether an application is included in the specific applications can be determined on the basis of the data items 205 and 206.

In Step S305, the user interface 124 notifies the platform unit 20 of one application corresponding to a selection instruction from the user, among the applications in the list.

In Step S306, the platform unit 20 determines whether the application for which the selection instruction is issued from the user and which has been installed (the application for which the selection instruction is issued from the user is hereinafter referred to as a destination application) can process the user generated data about the application to be uninstalled. This determination is based on whether the data format of the user generated data about the application to be uninstalled is included in the data item 205 (the processable data) for the destination application. If the platform unit 20 determines that the destination application can process the user generated data YES in Step S306), the process goes to Step S309. If the platform unit 20 determines that the destination application cannot process the user generated data (NO in Step S306), the process goes to Step S307.

In Step S307, the platform unit 20 determines whether the destination application can process the data format to which the platform unit 20 can perform the format conversion (the data format resulting from the format conversion of the user generated data managed by the application to be uninstalled). This determination is based on whether the data item 206 (the convertible data) of the application to be uninstalled is included in the data item 205 (the processable data) for the destination application.

If the platform unit 20 determines in Step S307 that the destination application cannot process the convertible data, the platform unit 20 displays an error message indicating that the destination application cannot process the convertible data with the user interface 124 and, then (NO in Step S307), the process goes to Step S311. In this case, the uninstallation is performed without moving the data.

If the platform unit 20 determines in Step S307 that the destination application can process the convertible data (YES in Step S307), then in Step S308, the platform unit 20 converts the data format of the user generated data. The conversion of the data format may be performed only by the platform unit 20. Alternatively, if the application to be uninstalled has a conversion function, the conversion function of the application may be used to perform the conversion of the data format. In the latter case, the conversion is performed by the platform unit 20 that invokes the conversion function of the destination application. This causes all the user generated data in the data management area managed by the destination application to be converted into a specific format. The specific format means the format that is indicated in the data item 205 as the processable data for the destination application and that is indicated in the data item 206 as the convertible data for the destination application. If multiple convertible formats are indicated in the data item 206, the format that has been registered first is selected. Alternatively, the user may select a format with the user interface 124. When the format conversion is completed, the process goes to Step S309.

In Step S309, the platform unit 20 detects the data management area of the destination application. The detection is performed by the platform unit 20 that acquires the value from the data item 203 in the record of the destination application. In Step S310, the platform unit 20 moves the user generated data about the application to be uninstalled to the data management area of the destination application detected in Step S309.

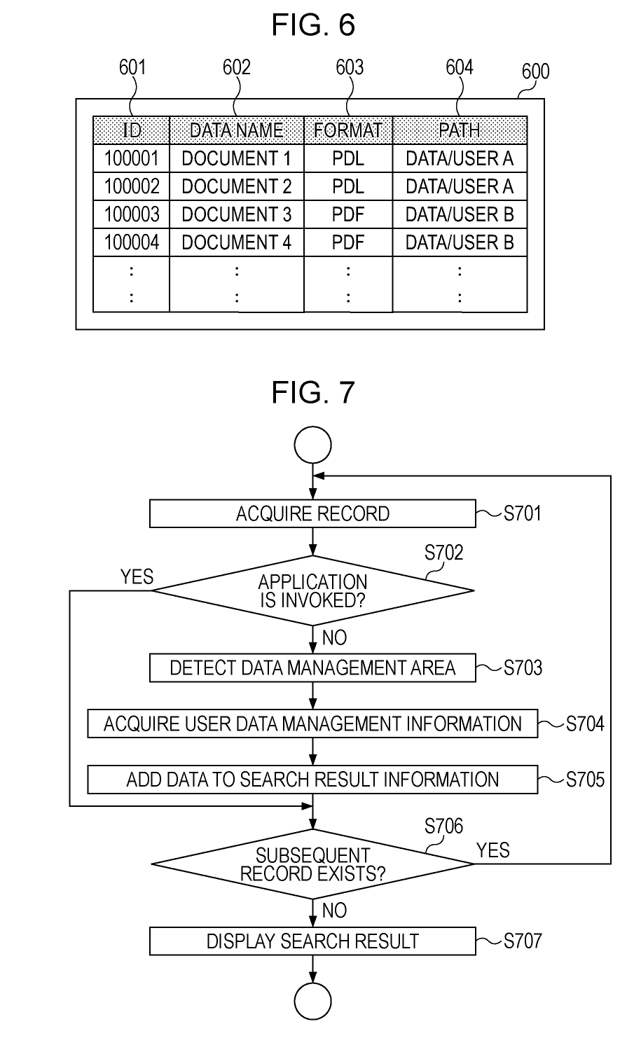

In Step S311, the platform unit 20 uninstalls the application. In addition, the platform unit 20 deletes all the data in the data item 203 indicating the data management area managed by the application. As a result, the user generated data determined to be negative in Step S307, the information (the table in FIG. 6) used for managing the user generated data, and the application are deleted to open the data management area. The platform unit 20 also deletes the record for the application to be uninstalled from the table in FIG. 2A in Step S311.

All the user generated data that cannot be moved to the destination application is deleted in the first exemplary embodiment of the present invention. In contrast, according to a second exemplary embodiment of the present invention, the user generated data that cannot be moved is not deleted but is left. Although the capacity of the indirect storage unit 123 is consumed, compared with the first exemplary embodiment, the user generated data is not deleted in association with the uninstallation of the corresponding application.

However, the user cannot access the user generated data about an application that is not invoked unless special measures are taken. Accordingly, search for invalid data is performed in the second exemplary embodiment.

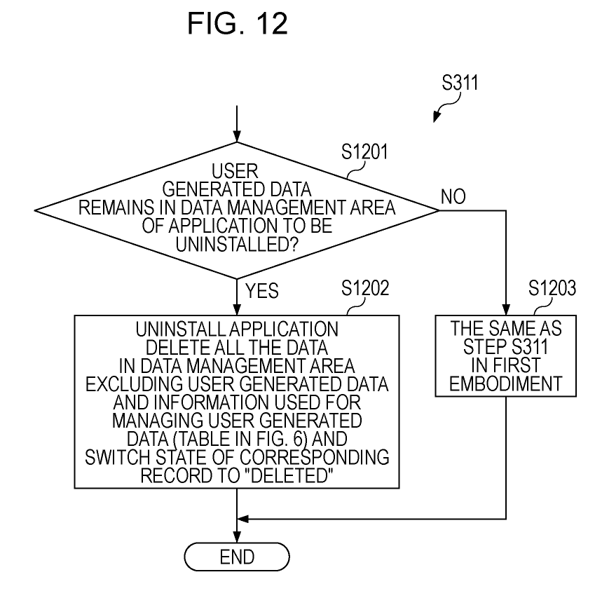

The second exemplary embodiment differs from the first exemplary embodiment only in Step S311. Step S311 in the second exemplary embodiment will now be described in detail. Step S311 in the second exemplary embodiment includes the steps from Step S1201 to Step S1203 in FIG. 12.

Referring to FIG. 12, in Step S1201, the platform unit 20 determines whether the user generated data remains in the data management area of an application to be uninstalled. This determination is the same as in Step S303. If the platform unit 20 determines that the user generated data remains (YES in Step S1201), the process goes to Step S1202. If the platform unit 20 determines that the user generated data does not remain (NO in Step S1201), the process goes to Step S1203. The process goes to Step S1203 if the user generated data is moved in Step S310 and does not remain in the data management area or if the user generated data does not originally exist in the data management area.

In Step S1202, the platform unit 20 uninstalls the application. First, the platform unit 20 deletes part of the data in the data item 203 indicating the data management area managed by the application. The part of the data means all the data in the data item 203 indicating the data management area, excluding the user generated data and the information (the table in FIG. 6) used for managing the user generated data. Specifically, the platform unit 20 deletes the application and the setup data necessary to operate the application as the part of the data. Since only the user generated data and the information (the table in FIG. 6) used for managing the user generated data remain in the data item 203 indicating the data management area as the result of the deletion, it is not necessary for the data management area to have the size before the uninstallation. Accordingly, the size of the data management area indicated in the data item 203 is reduced so as to contain the user generated data and the information used for managing the user generated data. Next, the platform unit 20 updates the value of the data item 203 indicating the data management area with the information indicating the address of the data management area subjected to the reduction in size. Next, the platform unit 20 switches the value of the data item 204 in the record of the application to be uninstalled to “Deleted” (refer to an in-device document management application shown in FIG. 2B). The switching to “Deleted” causes the user generated data about the application to be a target for a process of searching for invalid data described below with reference to FIG. 7.

In Step S1203, the platform unit 20 uninstalls the application. Since Step S1203 is the same as Step S311 in the first exemplary embodiment, a description is omitted herein.

FIG. 5 illustrates an example of the hierarchical structure of the data management area (indicated in the data item 203 in FIG. 2A) managed by the platform unit 20. This hierarchical structure is built in the indirect storage unit 123.

A first hierarchy includes a system area 501, an application program area 502, and a user data area 505.

The system area 501 includes basic programs used for operating the platform unit 20 and the image processor 12, various setup files, temporary files, and so on.

The application program area 502 has a second hierarchy built thereon. Areas 503 and 504 in which applications and setup data necessary to operate the applications are stored are arranged on the second hierarchy. The area of each application on the second hierarchy is part of the data management area generated when the application is installed.

The user data area 505 has the second hierarchy built thereon. Areas (user-generated-data storage areas) 506 and 507 in which the user generated data about each application is stored are arranged on the second hierarchy. The areas on the second hierarchy are used by each application to store the user generated data generated by using the application. The areas are also used to store the management information about the user data. The area of each application on the second hierarchy is part of the data management area generated when the application is installed.

FIG. 6 is a table illustrating an example of the data structure of management information about the user generated data managed in the management area of one application.

Each application stores and manages user data management information 600 on the second hierarchy of the user data area 505 in the data management area of the application. Since the format of the user data management information 600 and the location of the management information in the data management area are defined in advance, the platform unit 20 can access the management information. For example, the management information is stored at the first address of the block A in the area 506 in the user data area 505.

Referring to FIG. 6, a data item 601 indicates the ID of each piece of user data and the ID in the data item 601 is unique in the user data management information 600. Since the ID in the data item 601 is represented in combination with the ID of the application, the ID in the data item 601 is unique in the management tables of other applications. For example, user data represented by an ID “100001” is the first data in the user data managed by the print application having the ID “00001”, and user data represented by an ID “200001” is the second data in the user data managed by the print application having the ID “00001”.

A data item 602 indicates the name of each piece of user data.

A data item 603 indicates the data format of each piece of user data. The extension used in the file name of the user data is set as the value of the data item 603, as in the data item 205. A data item 604 indicates the path of the storage area in which each piece of user data is stored.

One row of the user data management information 600 is called a record. The record includes the data items 601, 602, 603, and 604. The record represents the management information about one piece of user data.

When the user generates user data, each application adds a record to the user data management information 600. When user data is deleted, each application deletes the record corresponding to the user data from the user data management information 600.

When the user wants to access the user data managed by a specific application, the user selects the specific application with the user interface 124. For example, when the user wants to access the user data managed by a Copy application, the user touches a “Copy” button on a display screen illustrated in FIG. 8A to select the Copy application. The user can access the user data managed by the Copy application on a screen displayed by the selection. Only the buttons corresponding to the applications that are invoked are displayed on the display screen in FIG. 8A. The user can issue an instruction about the application corresponding to a button which the user has pressed. The display of only the buttons corresponding to the applications that are invoked allows the number of displayed applications to be decreased, thereby improving the user-friendliness.

However, the user cannot access the user data managed by applications that are not invoked. In order to resolve this problem, a method for enabling the user to access the user data managed by an application that is not invoked will now be described. Specifically, an invalid document search button 802 is provided on the display screen, as in an example illustrated in FIG. 8B. How to use the invalid document search button 802 will be described here. The user data managed by an application that is not invoked is hereinafter referred to as invalid data.

FIG. 7 is a flowchart showing an example of a process of searching for the invalid data, performed by the platform unit 20, according to the second exemplary embodiment of the present invention.

At reception of an instruction to search for the invalid data from the user, the user interface 124 notifies the platform unit 20 of the reception of the instruction. The platform unit 20 performs the process shown in FIG. 7 in response to the notification. The user issues the instruction to search for the invalid data by touching the corresponding button on a user interface screen 800 illustrated in FIG. 8B.

The screen in FIG. 8B will be briefly described here. The screen 800 in FIG. 8B is a menu screen used by the user to select an application. An application button group 801 includes the buttons indicating applications invoked by the platform unit 20. The invalid document search button 802 is used to search for an invalid document.

Referring back to FIG. 7, at reception of the above notification, the platform unit 20 detects an application that is not invoked from all the applications listed in the application management data 200. This detection is performed by the platform unit 20 that confirms the value of the data item 204 indicating the state of each application in the record in the application management data 200 (a series of processing in Steps S701, S702, and S706). Specifically, in Step S701, the platform unit 20 acquires a record from the application management data 200. The platform unit 20 sequentially acquires the records one by one from the first record.

In Step S702, the platform unit 20 determines whether the application corresponding to the acquired record is invoked. The determination is based on whether the value of the data item 204 in the record is “Invoked” (or “Deleted” or “Stopped”). If the platform unit 20 determines that the application is invoked (YES in Step S702), the process goes to Step S706. If the platform unit 20 determines that the application is not invoked (NO in Step S702), the process goes to Step S703.

Next, the platform unit 20 searches for the user data stored in the management area of the application that is determined not to be invoked. This search is performed by a series of processing in Steps S703 to S705.

Specifically, in Step S703, the platform unit 20 detects the data management area of the application determined not be invoked in Step S702. The detection is performed by the platform unit 20 that acquires the value of the data item 203 in the record acquired in Step S701.

In Step S704, the platform unit 20 acquires the user data management information 600 stored in the detected data management area. Since the list of the user generated data stored in the data management area is described in the acquired user data management information 600, the platform unit 20 extracts all the user data management information 600 in the direct storage unit 122 as search result information. In Step S705, the platform unit 20 adds the above user data management information 600 to the search result information if the search result information exists in the direct storage unit 122.

If the processing for the record acquired in Step S701 proceeds to Step S705, then in Step S706, the platform unit 20 determines whether the subsequent record exists. If the platform unit 20 determines that the subsequent record exists (YES in Step S706), the process goes back to Step S701. If the platform unit 20 determines that the subsequent record does not exist (NO in Step S706), the process goes to Step S707.

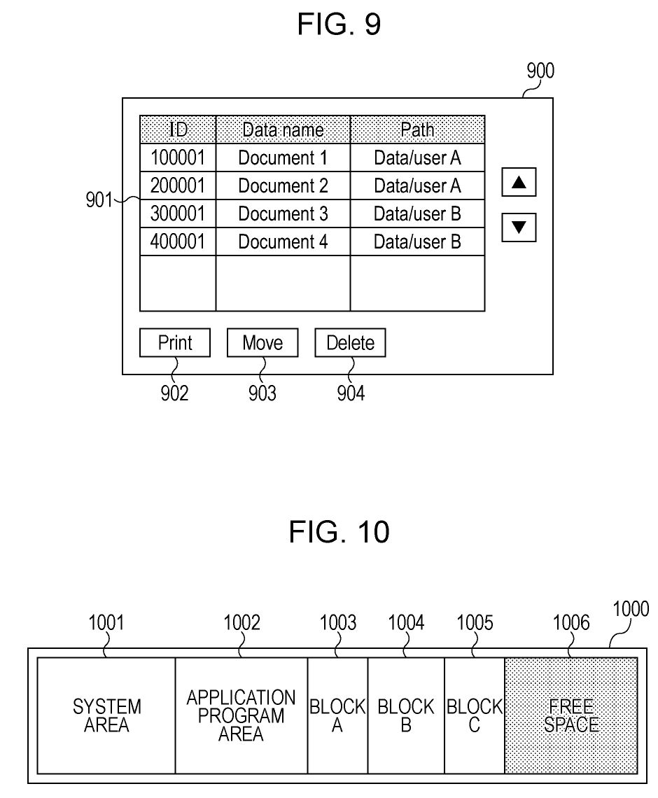

In Step S707, the platform unit 20 displays the search result information stored in Step S705 in the user interface 124. Then, the process of searching for the invalid data in FIG. 7 is terminated. For example, the search result information is displayed as in an example illustrated in FIG. 9. The user can subsequently access (for example, browse, edit, or print) the user generated data in the search result information with the user interface 124.

The platform unit 20 searches for the invalid data in the manner described above, and the user can effectively use the user data which the user has generated according to the process performed by the platform unit 20.

A screen 900 illustrated in FIG. 9 is used to display the result of the invalid document search. The screen 900 is displayed in Step S707 in FIG. 7.

Referring to FIG. 9, a search result list 901 includes the data items indicating the ID, the data name, and the path of each document. The ID, the data name, and the path correspond to the data items 601, 602, and 604 in the user data management information 600 in FIG. 6.

Reference numerals 902, 903, and 904 denote processing buttons. The user selects an intended document from the search result list 901 and presses any of the processing buttons to perform intended processing.

When the apparatus according to the second exemplary embodiment is used, the following processes are performed in uninstallation of the in-device document management application. Since no application can process the data in the NATIVE format indicated as the processable data of the in-device document management application, the user data in the NATIVE format is converted into the user data in the PDF format. Then, the user data in the PDF format in the user-generated-data storage areas of the in-device document management application is moved to the user-generated-data storage areas of the print application that can process the user data of the PDF format.

The method of searching for the invalid data in the state where, for example, the application management information is used to manage the state of an application is described in the second exemplary embodiment. According to a third exemplary embodiment, another method of searching for the invalid data will be described.

FIG. 10 illustrates an example of the logical structure of the indirect storage unit 123. Referring to FIG. 10, a real data space 1000 is logically divided into multiple areas including a system area 1001, an application program area 1002, a user data area (including a block A 1003, a block B 1004, and a block C 1005), and a free space 1006.

The system area 1001 includes basic programs used for operating the platform unit 20 and the image processor 12, various setup files, temporary files, and so on.

The application program area 1002 includes various programs that are installed. Each program may be stored in the hierarchical structure illustrated in FIG. 5.

Each application stores the user data in the user data area including the block A 1003, the block B 1004, and the block C 1005. The user data area is generated by the platform unit 20 when each application is installed. The data stored in each user data area is managed by using the user data management information, as in the second exemplary embodiment.

The platform unit 20 acquires the data management area from the free space 1006 when a new application is to be installed.

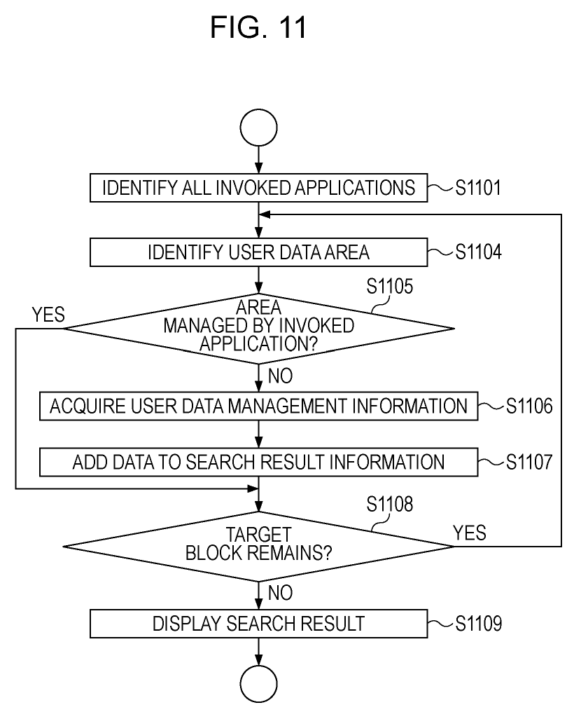

FIG. 11 is a flowchart showing an example of a process of searching for invalid data, performed by the platform unit 20, according to the third exemplary embodiment of the present invention.

At reception of an instruction to search for the invalid data from the user, the user interface 124 notifies the platform unit 20 of the reception of the instruction. The platform unit 20 performs the process shown in FIG. 11 in response to the notification.

In Step S1101, the platform unit 20 identifies all the applications that are invoked in the direct storage unit 122. This step is performed via an application program interface (API) that is defined in advance. It is necessary to support the API for the operation in the platform unit 20.

In Step S1104, the platform unit 20 identifies the user data area (the block A 1003, the block B 1004, and the block C 1005) illustrated in FIG. 10. The user data area is identified with a logical name, such as the block A, the block B, or the block C.

In Step S1105, the platform unit 20 determines whether the target block is managed by the invoked application. If the platform unit 20 determines that the target block is managed by the invoked application (YES in Step S1105), the process goes to Step S1108. If the platform unit 20 determines that the target block is not managed by the invoked application (NO in Step S1105), the process goes to Step S1106.

In Steps S1106 and S1107, the platform unit 20 performs the search for the user data included in the target block. Steps S1106 and S1107 are the same as Steps S704 and S705 in FIG. 7.

In Step S1108, the platform unit 20 determines whether a target block remains. If the platform unit 20 determines that a target block remains (YES in Step S1108), the process goes back to Step S1104. If the platform unit 20 determines that no target block remains (NO in Step S1108), the process goes to Step S1109. In other words, after the platform unit 20 performs Steps S1104 to S1107 for all the blocks in the user data area, the process goes to Step S1109.

In Step S1109, the platform unit 20 displays the search result information stored in Step S1107 in the user interface 124. Then, the process of searching for the invalid data in FIG. 11 is terminated.

As described above, according to the third exemplary embodiment of the present invention, even if the invocation state of the application is not managed on the table, the platform unit 20 searches for the invalid data in the manner described above, and the user can effectively use the user data which the user has generated according to the process performed by the platform unit 20.

The advantages of the exemplary embodiments described above can be realized by providing a control method of executing each step, a program causing a computer to execute each step, or a storage medium storing the program.

Although one apparatus performs all the processes in the above exemplary embodiments, multiple apparatuses included in a system may perform the processes in cooperation with each other.

It is assumed that the trial period is set for an application and the application whose trial period is expired is to be uninstalled from the image forming apparatus in the above exemplary embodiments. When the application is uninstalled from the image forming apparatus in the above case, there are problems in that the information generated and managed by the application becomes inaccessible and the user, for example, cannot refer to or print the information.

In contrast, the above problems are not caused in devices including a personal computer (PC) and a portable information terminal such as a personal digital assistant (PDA) although applications are uninstalled in such devices in association with update or replacement of the applications. This is because the device, such as the PC, includes software only for management of folders and files and the files generated by each application can be accessed even after the application is uninstalled. In the case of the PC using, for example, Windows (registered trademark) as the OS, the management of folders and files is realized by file management software (file management function) called Explorer.

The user can keep track of, open, or search for a target file in the PC without being dependent on each application owing to the provision of the Explorer. The use of the Explorer allows a PDF file to be accessed even after a PDF file generation application is uninstalled from the PC.

The above problems are caused in the image forming apparatus because of the difference in configuration between the PC and the image forming apparatus. Specifically, since the capacity of the information storage unit of the image forming apparatus is much smaller than that of the PC, it is difficult for the image forming apparatus to incorporate independent data management software, such as the Explorer, that is not dependent on each application.

This will be described in more detail. The file management software used in PCs has various functions including a function of displaying a list of files in various formats, a function of searching for a file and moving, copying, or deleting the file, and a function of displaying a file reference history. The software that has many functions and that is independent of applications consumes a large amount of system resource (the storage capacity of the information storage unit). Accordingly, the software only for file management independent of applications cannot be adopted in the image forming apparatuses having lower capacities of the information storage units, compared with the PCs. As a result, a file generated by an application is stored in a storage unit dependently on the application in the image forming apparatus. In other words, a file generated by a specific application is stored in the management area (folder) of the application. Specifically, a case where a document management application installed in an image forming apparatus is uninstalled will now be described in detail. The document management application is software that stores documents that are scanned or that are received from an external information processing apparatus in the HDD in the image forming apparatus to provide the document management function. The document management application allows the user to access the document and to operate (for example, print or transmit) the document. When the document management application is uninstalled from the image forming apparatus, not only the document management application cannot be used but also the scanned documents or the externally received documents, stored in the HDD, cannot be subsequently accessed. In such a situation, it is necessary to install the document management application that is uninstalled again in order for the user to access the document information stored in the HDD. The reinstallation of the document management application imposes a burden on the user. In addition, the user may know how to reinstall the application. In such a case, it is necessary for the user to inquire of a service center about the reinstallation method or to request call-out of a service staff, thereby imposing a burden on the vendor of the image forming apparatus.

While the present invention has been described with reference to exemplary embodiments, it is to be understood that the invention is not limited to the disclosed exemplary embodiments. The scope of the following claims is to be accorded the broadest interpretation so as to encompass all modifications and equivalent structures and functions.

This application claims the benefit of Japanese Patent Application No. 2008-160776 filed Jun. 19, 2008 and No. 2008-296699 filed Nov. 20, 2008, which are hereby incorporated by reference herein in their entirety.

What is claimed is:

1. An apparatus uninstalling a target application, the apparatus comprising:
a processing unit configured to move user generated data from a user-generated-data storage area managed by the target application to be uninstalled to a user-generated-data storage area managed by another application that is installed.

2. The apparatus according to claim 1,
wherein the processing unit converts a format of the user generated data for the target application to be uninstalled into a format for the other application that is installed in a movement of the target application to be uninstalled.

3. An apparatus comprising:
an identifying unit configured to identify an application that is not invoked; and
a search unit configured to search a user-generated-data storage area of the identified application for user generated data.

4. An apparatus comprising:
an identifying unit configured to identify a user-generated-data storage area that is not managed by an application that is invoked from user-generated-data storage areas; and
a search unit configured to search the identified user-generated-data storage area for a document.

5. A method of controlling an apparatus that uninstalls a target application, the method comprising:
moving user generated data from a user-generated-data storage area managed by the target application to be uninstalled to a user-generated-data storage area managed by another application that is installed.
